(19) United States
(12) Patent Application Publication
(10) Pub. No.: US 2015/0189490 A1
(43) Pub. Date: Jul. 2, 2015

(54) ORCHESTRATING USER DEVICES TO FORM IMAGES AT VENUE EVENTS

(71) Applicant: Verizon Patent and Licensing Inc., Basking Ridge, NJ (US)

(72) Inventors: Victor D. Chan, Newton, MA (US); Steven T. Archer, Dallas, TX (US); Abby Charfauros, San Diego, CA (US); Paul Hubbard, San Diego, CA (US); Paul Hubner, McKinney, TX (US); Robert Andersen, Chicago, IL (US); Chunyee Leung, Lexington, MA (US)

(73) Assignee: Verizon Patent and Licensing Inc., Basking Ridge, NJ (US)

(21) Appl. No.: 14/144,898

(22) Filed: Dec. 31, 2013

(51) Int. Cl. H04W 8/02; H04W 8/24; G09G 5/12; H04W 4/02

(52) U.S. Cl. CPC H04W 8/02; H04W 4/02; H04W 8/24; G09G 5/12; G09G 2370/022

(57) ABSTRACT

A method, performed by one or more computer devices, may include generating a sequence script for a venue event, wherein the sequence script is configured to synchronize a plurality of user devices located at the venue during the venue event to form one or more images discernable when the devices are viewed collectively. The method may further include obtaining user registration information associated with the venue event, wherein the user registration information identifies user devices registered to participate in the generation of the one or more images; detecting a trigger event associated with the sequence script; and orchestrating the plurality of user devices to form the one or more images, in response to detecting the trigger event.

### BACKGROUND INFORMATION

Spectators at large scale events, such as sport stadiums, often participate in group activities while attending an event. For example, the spectators may perform a group chant to cheer on a sports team, may hold up lighters in the air, or may stand up or raise their arms to participate in a wave that travels through a section of the stadium. The spectators may find it difficult to coordinate such participatory events.

### BRIEF DESCRIPTION OF THE DRAWINGS

FIG. 1 is a diagram illustrating an environment according to an implementation described herein;

FIG. 2 is a diagram illustrating exemplary components of the user device of FIG. 1;

FIG. 3 is a diagram illustrating exemplary functional components of the user device of FIG. 1;

FIG. 4 is a diagram illustrating exemplary components of a device that may be included in one of the systems of FIG. 1;

FIG. 5A is a diagram illustrating exemplary functional components of the designer system of FIG. 1;

FIG. 5B is a diagram illustrating exemplary components of the sequence database of FIG. 5B;

FIG. 6 is a diagram illustrating exemplary functional components of the orchestration system of FIG. 1;

FIG. 7 is a flowchart for generating and executing a sequence script according to an implementation described herein;

FIG. 8 is a flowchart for designing a sequence script according to an implementation described herein;

FIG. 9 is a flowchart for orchestrating a sequence script according to an implementation described herein;

FIG. 10 is a flowchart for executing a sequence script according to an implementation described herein;

FIGS. 11A-11G are diagrams illustrating a first exemplary scenario according to an implementation described herein;

FIG. 12 is a diagram illustrating a second exemplary scenario according to an implementation described herein; and

FIG. 13 is a diagram of an exemplary user device according to an implementation described herein.

### DETAILED DESCRIPTION OF PREFERRED EMBODIMENTS

The following detailed description refers to the accompanying drawings. The same reference numbers in different drawings identify the same or similar elements.

Implementations described herein relate to orchestrating user devices to display images or perform other synchronized actions at venue events. The orchestration of a large number of user devices, performed with or without a human operator via one or more computer systems, may result in a collective visual, audio, and/or tactile effect similar to a large scale television screen. For example, users may register at a venue event, such as a sports game at a stadium or a music performance at a concert venue, to participate in an orchestrated event with other users. The orchestrated event may include, for example, one or more images being formed by user devices (e.g., mobile phones), wherein the display of each user device corresponds to one pixel, or a group of pixels, of an image. The user devices may together form a large-scale display device that executes a sequence of one or more images. For example, when viewed together as a large display device, and while the users are in their seats and holding up their user devices during the venue event, the user devices may together display a textual message to encourage a sports team, display the team's logo, generate an animation, perform an audience wave, and/or display other types of images. A sequence may also include audio components.

A designer system may be configured to enable a designer (such as a human administrator associated with a venue event) to generate a sequence script for a sequence to be orchestrated during the venue event. The designer system may obtain a seating plan, or another type of map, for the venue event, may obtain one or more files to be rendered during the sequence, and may map the obtained files to the seating plan. Furthermore, a trigger event may be selected for executing the sequence, such as a particular action or period of time occurring during the venue event (e.g., seventh inning stretch, a team scoring, etc.).

An orchestration system may be configured to orchestrate the sequence based on the sequence script. The orchestration system may obtain registration information for the venue event. Users may register to participate in sequences to be executed during the venue event. Users may register by scanning a quick response (QR) code associated with the venue event, by scanning a ticket for the venue event, by accepting an invite to register sent to the user's device, by communicating with a neighboring user device at the venue, by communicating with a wireless transceiver at the venue, and/or using another registration process. The registration information may be correlated with the mapped files to determine which seats at the venue include users who are willing to participate in the execution of a sequence. The mapping may be adjusted to take into account the registration information, such as when there are insufficient users in a part of an image to be formed, which may be caused, for example, by an empty or sparsely occupied section in the seats.

The orchestration system may provide an action script for a sequence to registered user devices. When the trigger event is detected, the orchestration system may instruct the registered user devices to execute the action script. The action script may provide instructions to each registered user selected for participation (e.g., “hold up your device now”). The action script may display an image, activate a flash, play an audio or video file, interface with an accessory device, and/or may perform other actions associated with the sequence, such as displaying, activating, playing, interfacing and performing occurring on, or with respect to, the registered user device of each registered user. The visual effect perceived from the plurality of user devices acting in concert may be akin to that which might be perceived from a large scale television screen.

Moreover, one or more advertisements, promotions, and/or rewards may be associated with the sequence script. As an example, a promotion system may monitor user participation and may provide a user with a reward in return for participating in a sequence. As another example, an advertisement may be displayed on the user's device. As yet another example, an advertisement may be formed during the sequence by the participating user devices.

Furthermore, an analysis system may collect information relating to an executed sequence and may perform analysis on the collected participation information. For example, the analysis system may determine a participation rate associated with the sequence script, may determine a satisfaction rate associated with the sequence script, may determine a number of advertisements presented in connection with the sequence script, and/or may determine a number of redeemed rewards associated with the sequence script.

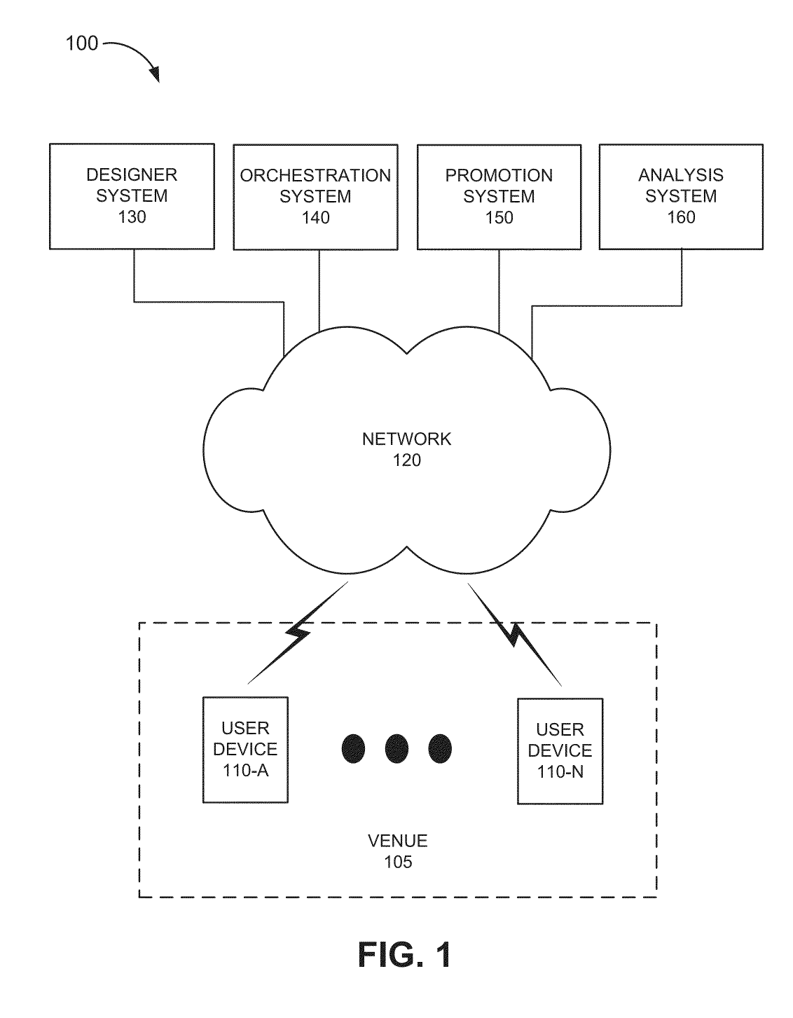

FIG. 1 is a diagram of an exemplary environment 100 in which the systems and/or methods described herein may be implemented. As shown in FIG. 1, environment 100 may include a venue 105, a network 120, a designer system 130, an orchestration system 140, a promotion system 150, and an analysis system 160.

Venue 105 may correspond to a sporting venue (e.g., a stadium), a music venue (e.g., a concert hall), a performing arts venue (e.g., a theater), and/or another type of location where users, and/or particular user groups (e.g., a group of friends, an association, a school, a company, etc.), may gather to watch, and/or participate in, a performance or another type of event. Venue 105 may be associated with a seating plan and/or another type of map showing likely locations of users during a venue event.

Venue 105 may include, or be associated with, user devices 110-A to 110-N (referred to herein collectively as “user devices 110” and individually as “user device 110”). User device 110 may include any device enabled to receive messages from orchestration system 140 and including an output device. For example, user device 110 may include a portable communication device (e.g., a mobile phone, a smart phone, a phablet device, a global positioning system (GPS) device, and/or another type of wireless device); a personal computer or workstation; a server device; a laptop, tablet, or another type of portable computer; a media playing device; a portable gaming system; and/or any other type of computer device with communication and output capabilities. In other implementations, user device 110 may include a device designed to be used in venue 105 and configured to communicate with orchestration system 140. For example, user device 110 may include a sports paraphernalia item with a wireless/wired transceiver and one or more output items (e.g., light emitting diodes (LEDs), a speaker, etc.).

Network 120 may enable user devices 110 to communicate with each other and to communicate with one or more of designer system 130, orchestration system 140, promotion system 150, and/or analysis system 160. Network 120 may include one or more circuit-switched networks and/or packet-switched networks. For example, network 120 may include a local area network (LAN), a wide area network (WAN), a metropolitan area network (MAN), a Public Switched Telephone Network (PSTN), an ad hoc network, an intranet, the Internet, a fiber optic-based network, a wireless network, and/or a combination of these or other types of networks.

Designer system 130 may include one or more devices, such as computer devices and/or server devices, which are configured to enable a designer to design a sequence script for a sequence to be executed during a venue event. For example, designer system 130 may provide a user interface configured to upload a seating plan and/or another type of map; upload files such as images, animations, and/or videos; and to map the uploaded files to the uploaded seating plan. The user interface may also enable the designer to draw a pattern or textual message onto a seating plan and/or map and may enable the designer to select a sequence of patterns, textual messages, and/or images to be formed during execution. Furthermore, designer system 130 may include a simulator to enable the designer to test a sequence script.

Orchestration system 140 may include one or more devices, such as computer devices and/or server devices, which are configured to orchestrate execution of a sequence script designed using designer system 130. For example, orchestration system 140 may obtain registration information associated with a venue event to determine which users have selected to participate in executing sequences and may correlate a mapping on a seating plan with the registered users. Orchestration system 140 may provide an action script to user devices 110 associated with registered users. Orchestration system 140 may detect a trigger event associated with the sequence script and may instruct the user devices 110 to execute the action script received from orchestration system 140 in response to detecting the trigger event.

Promotion system 150 may include one or more devices, such as computer devices and/or server devices, which are configured to provide an advertisement, promotion, and/or reward in connection with a sequence script. For example, promotion system 150 may store advertisements, promotions, and/or rewards and may select a particular advertisement, promotion, and/or reward based on a category, keyword, venue, time period, location within the venue, and/or another criterion associated with a sequence script.

Analysis system 160 may include one or more devices, such as computer devices and/or server devices, which are configured to collect information relating to an execution of a sequence script and to perform analysis on the collected information. For example, analysis system 160 may determine a participation rate associated with a sequence script, may determine a satisfaction rate associated with the sequence script, may determine a number of advertisements presented in connection with the sequence script, may determine a number of redeemed rewards associated with the sequence script, and/or may perform other types of analysis on collected information.

Although FIG. 1 shows exemplary components of environment 100, in other implementations, environment 100 may include fewer components, different components, differently arranged components, or additional components than the ones depicted in FIG. 1. Additionally or alternatively, one or more components of environment 100 may perform functions described as being performed by one or more other components of environment 100. For example, while FIG. 1 shows user devices 110 within venue 105, user devices 110 need not be located within venue 105 to participate in an orchestrated event. Furthermore, while FIG. 1 illustrates designer system 130, orchestration system 140, promotion system 150, and analysis system 160 as separate systems, one or more of designer system 130, orchestration system 140, promotion system 150, and analysis system 160 may be included within a single system or even within a single device (e.g., a single computer device, a single server device, etc.). Moreover, while FIG. 1 illustrates a single venue 105, a single network 120, a single designer system 130, a single orchestration system 140, a single promotion system 150, and a single analysis system 160 for illustration purposes, in practice, environment 100 may include multiple venues 105, multiple networks 120, multiple designer systems 130, multiple orchestration systems 140, multiple promotion systems 150, and/or multiple analysis systems 160.

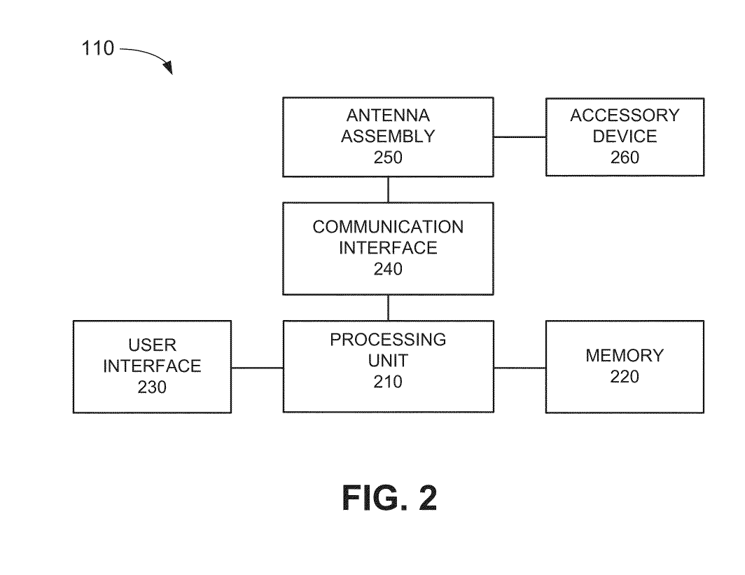

FIG. 2 is a diagram illustrating exemplary components of a user device 110 according to an implementation described herein. As shown in FIG. 2, user device 110 may include a processing unit 210, a memory 220, a user interface 230, a communication interface 240, an antenna assembly 250, and an accessory device 260.

Processing unit 210 may include one or more processors, microprocessors, application specific integrated circuits (ASICs), field programmable gate arrays (FPGAs), and/or other processing logic. Processing unit 210 may control operation of user device 110 and its components.

Memory 220 may include a random access memory (RAM) or another type of dynamic storage device, a read only memory (ROM) or another type of static storage device, a removable memory card, and/or another type of memory to store data and instructions that may be used by processing unit 210.

User interface 230 may allow a user to input information to user device 110 and/or to output information from user device 110. Examples of user interface 230 may include a speaker to receive electrical signals and output audio signals; a camera to receive image and/or video signals and output electrical signals; a microphone to receive sounds and output electrical signals; buttons (e.g., a joystick, control buttons, a keyboard, or keys of a keypad) and/or a touchscreen to receive control commands; a display, such as an LCD, to output visual information; an actuator to cause user device 110 to vibrate; a camera flash device; one or more light emitting diodes (LEDs); an accelerometer, gyroscope, and/or another type of position sensor; and/or any other type of input or output device.

Communication interface 240 may include a transceiver that enables user device 110 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 240 may include a transmitter that converts baseband signals to radio frequency (RF) signals and/or a receiver that converts RF signals to baseband signals. Communication interface 240 may be coupled to antenna assembly 250 for transmitting and receiving RF signals.

Communication interface 240 may include a logical component that includes input and/or output ports, input and/or output systems, and/or other input and output components that facilitate the transmission of data to other devices. For example, communication interface 240 may include a network interface card (e.g., Ethernet card) for wired communications and/or a wireless network interface (e.g., a WiFi) card for wireless communications. Communication interface 240 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

Antenna assembly 250 may include one or more antennas to transmit and/or receive RF signals. Antenna assembly 250 may, for example, receive RF signals from communication interface 240 and transmit the signals via an antenna and receive RF signals from an antenna and provide them to communication interface 240.

Accessory device 260 may include any device controllable by user device 110 via a short range wireless connection (e.g., Bluetooth, NFC, etc.) or via a wired connection (e.g., Universal Serial Bus (USB) connection, etc.). Accessory device 260 may include, for example, an external speaker, an external display device, LED gloves or another type of electroluminescent clothing worn by the user, and/or another type of output device. An action script associated with a sequence may include instructions to control accessory device 260 to perform particular actions.

As described herein, user device 110 may perform certain operations in response to processing unit 210 executing software instructions contained in a computer-readable medium, such as memory 220. A computer-readable medium may be defined as a non-transitory memory device. A non-transitory memory device may include memory space within a single physical memory device or spread across multiple physical memory devices. The software instructions may be read into memory 220 from another computer-readable medium or from another device via communication interface 240. The software instructions contained in memory 220 may cause processing unit 210 to perform processes that will be described later. Alternatively, hardwired circuitry may be used in place of, or in combination with, software instructions to implement processes described herein. Thus, implementations described herein are not limited to any specific combination of hardware circuitry and software.

Although FIG. 2 shows example components of user device 110, in other implementations, user device 110 may include fewer components, different components, differently arranged components, or additional components than those depicted in FIG. 2. Additionally or alternatively, one or more components of user device 110 may perform the tasks described as being performed by one or more other components of user device 110.

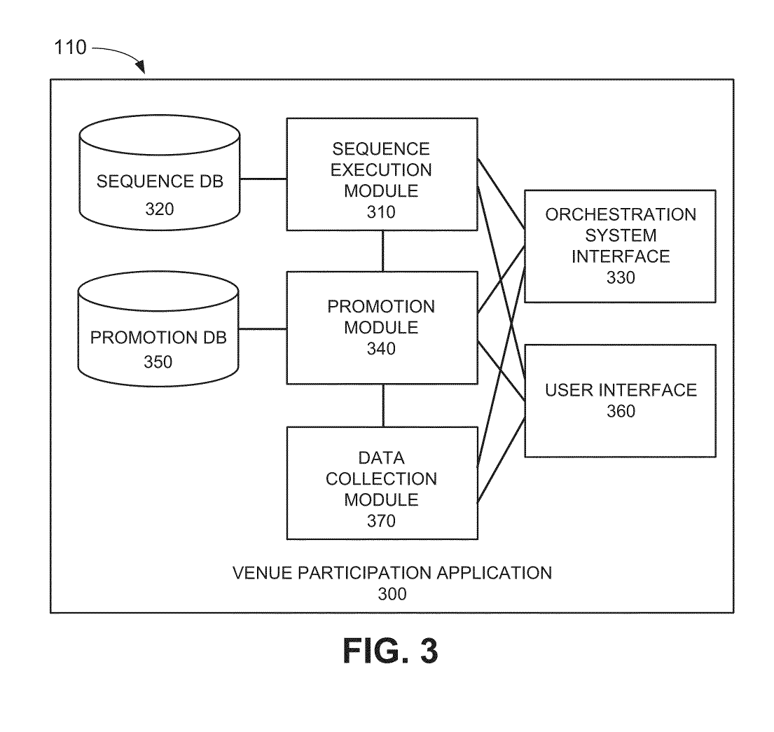

FIG. 3 is a diagram illustrating exemplary functional components of user device 110 according to an implementation described herein. The functional components of user device 110 may be implemented, for example, via processing unit 210 executing instructions from memory 220. Alternatively, some or all of the functional components of user device 110 may be implemented via hard-wired circuitry. As shown in FIG. 3, user device 110 may include a venue participation application 300. Venue participation application 300 may be configured to communicate with orchestration system 140 and may be provided to user device 110 in response to user device 110 registering for a venue event. Venue participation application 300 may include a sequence execution module 310, a sequence database (DB) 320, an orchestration system interface 330, a promotion module 340, a promotion DB 350, a user interface 360, and a data collection module 370.

Sequence execution module 310 may execute a particular sequence in response to receiving an instruction from orchestration system 140. For example, sequence execution module 310 may access sequence DB 320 and may execute an action script stored in sequence DB 320. The action script may provide directions to the user. The action script may cause a screen of user device 110 to flash, to display an image, to play a video file, and/or to play an animation; may cause a speaker to play an audio file; may cause a camera flash to turn on; may cause user device 110 to vibrate; and/or may cause another output device associated with user device 110 to activate. In some implementations, the action script may further interface with one or more accessory devices, such as accessory display or audio devices. For example, the action script may control an external speaker, LED gloves or electroluminescent clothing worn by the user, etc. The accessory devices may be controlled via a short range wireless connection, such as a Bluetooth connection and/or an NFC connection.

Orchestration system interface 330 may communicate with orchestration system 140 to receive an action script for a particular sequence and/or may receive an instruction from orchestration system 140 to execute a particular action script at a particular time. Promotion module 340 may provide an advertisement, a promotion, and/or a reward to the user in connection with the action script associated with the particular sequence. For example, promotion module 340 may retrieve an advertisement, promotion, and/or reward from promotion DB 350 and may present the advertisement, promotion, and/or reward to the user in connection with the action script.

User interface 360 may enable a user to receive instructions from sequence execution module 310 (e.g., a prompt to point user device 110 in a particular direction). Furthermore, user interface 360 may enable communication with another user device 110 via user interface 230. Data collection module 370 may collect information relating to the execution of a sequence script. For example, data collection module 370 may determine whether the user has participated during the execution of a sequence script, may prompt the user to rate a sequence script, may determine whether the user has clicked on an advertisement, may determine whether the user has redeemed a promotion and/or a reward, and/or may collect other types of information. Data collection module 370 may provide the collected information to analysis system 160.

Although FIG. 3 shows exemplary functional components of user device 110, in other implementations, user device 110 may include fewer functional components, different functional components, differently arranged functional components, or additional functional components than those depicted in FIG. 3. Additionally or alternatively, one or more functional components of user device 110 may perform functions described as being performed by one or more other functional components of user device 110.

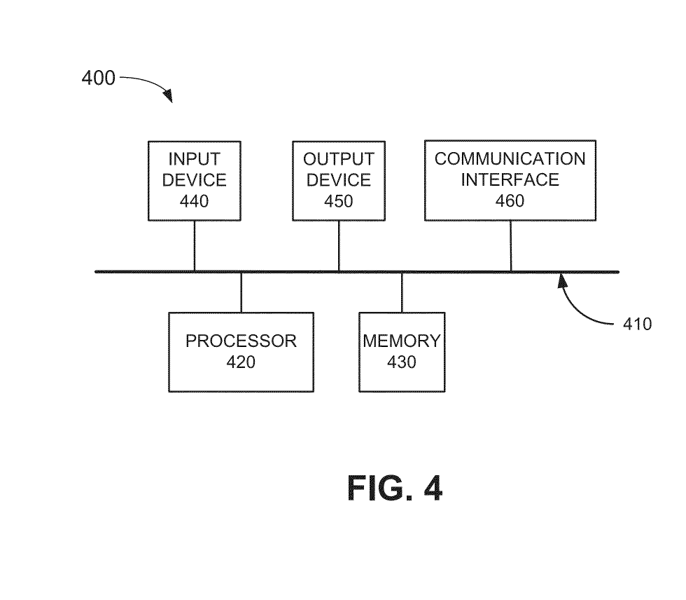

FIG. 4 is a diagram illustrating exemplary components of device 400 according to an implementation described herein. Each of designer system 130, orchestration system 140, promotion system 150, and/or analysis system 160 may include one or more devices 400. As shown in FIG. 4, device 400 may include a bus 410, a processor 420, a memory 430, an input device 440, an output device 450, and a communication interface 460.

Bus 410 may include a path that permits communication among the components of device 400. Processor 420 may include any type of single-core processor, multi-core processor, microprocessor, latch-based processor, and/or processing logic (or families of processors, microprocessors, and/or processing logics) that interprets and executes instructions. In other embodiments, processor 420 may include an application-specific integrated circuit (ASIC), a field-programmable gate array (FPGA), and/or another type of integrated circuit or processing logic.

Memory 430 may include any type of dynamic storage device that may store information and/or instructions, for execution by processor 420, and/or any type of non-volatile storage device that may store information for use by processor 420. For example, memory 430 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 440 may allow an operator to input information into device 400. Input device 440 may include, for example, a keyboard, a mouse, a pen, a microphone, a remote control, an audio capture device, an image and/or video capture device, a touch-screen display, and/or another type of input device. In some embodiments, device 400 may be managed remotely and may not include input device 440. In other words, device 400 may be “headless” and may not include a keyboard, for example.

Output device 450 may output information to an operator of device 400. Output device 450 may include a display, a printer, a speaker, and/or another type of output device. For example, device 400 may include a display, which may include a liquid-crystal display (LCD) for displaying content to the customer. In some embodiments, device 400 may be managed remotely and may not include output device 450. In other words, device 400 may be “headless” and may not include a display, for example.

Communication interface 460 may include a transceiver that enables device 400 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 460 may include a transmitter that converts baseband signals to radio frequency (RF) signals and/or a receiver that converts RF signals to baseband signals. Communication interface 460 may be coupled to an antenna for transmitting and receiving RF signals.

Communication interface 460 may include a logical component that includes input and/or output ports, input and/or output systems, and/or other input and output components that facilitate the transmission of data to other devices. For example, communication interface 460 may include a network interface card (e.g., Ethernet card) for wired communications and/or a wireless network interface (e.g., a WiFi) card for wireless communications. Communication interface 460 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 400 may perform certain operations relating to orchestrating user devices to display images or perform other synchronized actions at venue events. Device 400 may perform these operations in response to processor 420 executing software instructions contained in a computer-readable medium, such as memory 430. A computer-readable medium may be defined as a non-transitory memory device. A memory device may be implemented within a single physical memory device or spread across multiple physical memory devices. The software instructions may be read into memory 430 from another computer-readable medium or from another device. The software instructions contained in memory 430 may cause processor 420 to perform processes described herein. Alternatively, hardwired circuitry may be used in place of, or in combination with, software instructions to implement processes described herein. Thus, implementations described herein are not limited to any specific combination of hardware circuitry and software.

Although FIG. 4 shows exemplary components of device 400, in other implementations, device 400 may include fewer components, different components, additional components, or differently arranged components than those depicted in FIG. 4. Additionally or alternatively, one or more components of device 400 may perform one or more tasks described as being performed by one or more other components of device 400.

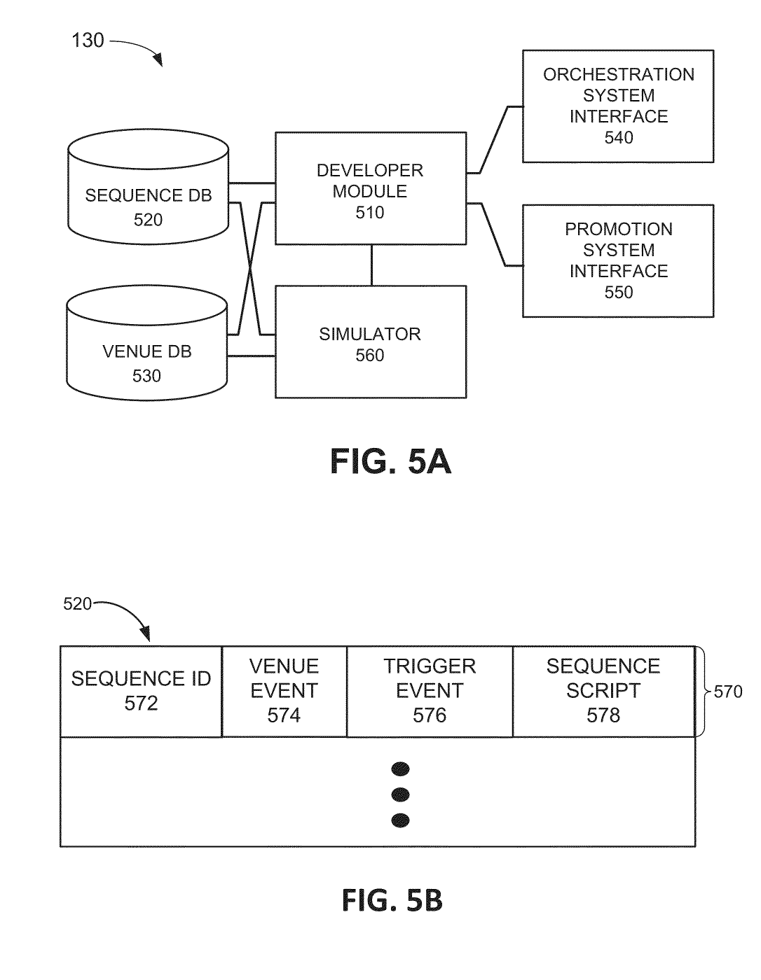

FIG. 5A is a diagram illustrating exemplary functional components of designer system 130. The functional components of designer system 130 may be implemented, for example, via processor 420 executing instructions from memory 430. Additionally or alternatively, some or all of the functional components of designer system 130 may be hard-wired. As shown in FIG. 5A, device 400 may include a developer module 510, a sequence DB 520, a venue DB 530, an orchestration system interface 540, a promotion system interface 550, and a simulator 560.

Developer module 510 may provide a user interface to a developer/designer to generate a sequence script for a sequence to be executed during a venue event. The user interface may be used to retrieve a seating plan from venue DB 530, to upload files such as images, animations, audio files, and/or video files, and to map the uploaded files to the uploaded seating plan. The user interface may also enable the designer to draw a pattern or textual message onto a seating plan and may enable the designer to select a sequence of patterns, textual messages, and/or images to be formed during execution. Sequence DB 520 may store information relating to particular sequence scripts generated using developer module. Exemplary information that may be stored in sequence DB 520 is described below with reference to FIG. 5B.

Venue DB 530 may store information relating to particular venues 105. For example, venue DB 530 may store a seating plan for a particular venue, may store a calendar associated with the particular venue, may store information relating to a venue event scheduled at the particular venue, and/or may store other information about the particular venue.

Orchestration system interface 540 may communicate with orchestration system 140. For example, orchestration system interface 540 may provide information relating to a particular sequence script from sequence DB 520 to orchestration system 140. Promotion system interface 550 may communicate with promotion system 150. For example, promotion system interface 550 may receive information relating to a particular advertisement, promotion, and/or reward that is to be associated with a particular sequence script.

Simulator 560 may enable a designer to simulate a sequence script stored in sequence DB 520. For example, simulator 560 may generate a simulation of venue 105, which may include an image of the seating plan, or another type of map, associated with venue 105. A sequence of images, animations, and/or videos, which have been mapped onto the seating plan and/or map, may be displayed, with a particular seat or location corresponding to a particular pixel (or another type of addressable element of an image) of a formed image from the sequence. A designer may evaluate the simulation and may either approve the sequence script or modify the sequence script and run another simulation.

Although FIG. 5A shows exemplary functional components of designer system 130, in other implementations, designer system 130 may include fewer functional components, different functional components, differently arranged functional components, or additional functional components than those depicted in FIG. 5A. Additionally or alternatively, one or more functional components of designer system 130 may perform functions described as being performed by one or more other functional components of designer system 130.

FIG. 5B is a diagram of exemplary components of sequence DB 520. As shown in FIG. 5B, sequence DB 520 may store one or more sequence records 570. Each sequence record 570 may store information relating to a particular sequence to be executed at a venue event. A sequence record 570 may include a sequence identifier (ID) field 572, a venue event field 574, a trigger event field 576, and a sequence script field 578.

Sequence ID field 572 may identify a particular sequence. Venue event field 574 may identify a particular venue 105 and a particular venue event associated with the particular sequence. Trigger event field 576 may identify one or more trigger events which may be used to activate the particular sequence. As an example, a trigger event may include receiving a manual instruction from an administrator associated with the venue event. As another example, a trigger event may correspond to a particular time period during the venue event (e.g., the beginning of half time during a sports game, the seventh inning stretch, etc.). As yet another example, a trigger event may correspond to a particular event occurring during the venue event (e.g., a team scoring, etc.).

As yet another example, a trigger event may be based on voting/selection by users of registered user devices 110 for a particular outcome. For example, the users may vote to select a favorite player and the player with the highest vote tally will have the player's theme song and/or image displayed by the crowd canvas of user devices 110 during a particular time period, such as at the end of a game period. As another example, orchestration system 140, venue 105, and/or another system, person, or device, may execute a lottery to select a user as the “fan of the day” and the selected user may pick a particular sequence to execute during the venue event.

Sequence script field 578 may store information relating to the sequence script associated with the particular sequence. For example, sequence script field 578 may identify a sequence of images that are to be formed during the sequence. For each particular image, sequence script field 578 may include a map that maps a particular pixel, or a set of pixels, to a particular seat, set of seats, or location, in the venue. The seat, set of seats, or location for a particular pixel, or set of pixels, may be identified via an absolute reference (e.g., seat 7F, GPS coordinates, etc.) or via a relative reference (e.g., 12 seats down and 10 seats across from a selected reference seat, GPS coordinate offset specifications, etc.). Moreover, the particular pixel, set of pixels, or location may be associated with an audio file that is to be played by a user device 110 associated with the particular pixel, set of pixels, or location. Sequence script field 578 may also include instructions that are to be presented to a user associated with user device 110 and may include an action script that is to be provided to user device 110 and executed by user device 110. For example, the action script may cause user device 110 to display a particular color, emit a particular sound, activate a camera flash device, and/or perform another action or set of actions. Furthermore, the sequence script may specify a length of time that the particular image is to be presented. The sequence script may also specify a display pattern for a particular image, such as a steady image, a flashing or strobing image, an image that increases in brightness intensity over time, etc.

Although FIG. 5B shows exemplary components of sequence DB 520, in other implementations, sequence DB 520 may include fewer components, different components, differently arranged components, or additional components than depicted in FIG. 5B.

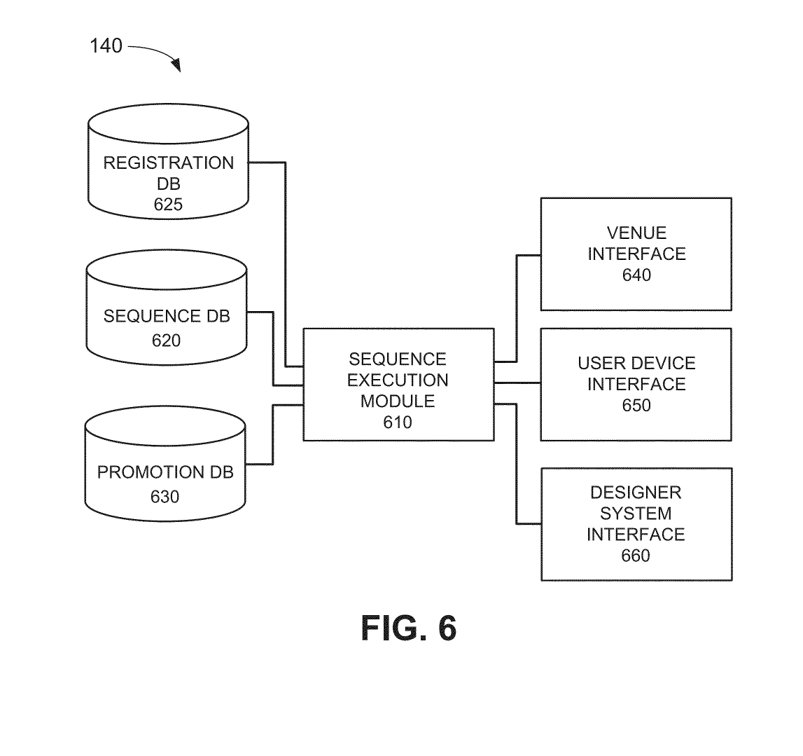

FIG. 6 is a diagram illustrating exemplary functional components of orchestration system 140. The functional components of orchestration system 140 may be implemented, for example, via processor 420 executing instructions from memory 430. Additionally or alternatively, some or all of the functional components of orchestration system 140 may be hard-wired. As shown in FIG. 6, device 400 may include a sequence execution module 610, a sequence DB 620, a registration DB 625, a promotion DB 630, a venue interface 640, a user device interface 650, and a designer system interface 660.

Sequence execution module 610 may control execution of a sequence script. For example, sequence execution module 610 may identify registered user devices 110, may associate a particular user device 110 with a particular mapped seat or location, and may provide an action script associated with the particular mapped seat or location to the particular user device 110. When sequence execution module 610 detects a trigger event associated with a sequence, sequence execution module 610 may instruct user devices 110 to execute the action scripts received from orchestration system 140.

Sequence DB 620 may include information associated with particular sequence scripts. For example, for a sequence script, sequence DB 620 may include information from sequence DB 520. Additionally, sequence DB 620 may include registration information relating to user devices 110 that have registered with a venue event associated with the sequence script. Sequence execution module 610 may map the registered user devices 110 to seats and/or locations identified in the sequence script.

Registration DB 625 may store registration information associated with user devices 110. For example, registration DB 625 may identify a user device 110 that has registered for the venue event, along with seat and/or location information associated with user device 110. A registered user device 110 may be identified based on a mobile device identifier (e.g., a Mobile Subscriber Integrated Services Digital Network number (MSISDN), an International Mobile Subscriber Identity (IMSI) number, a mobile identification number (MIN), an International Mobile Equipment Identifier (IMEI), an Integrated Circuit Card Identifier (ICCI), and/or any other mobile communication device identifier); an Internet Protocol (IP) address associated with a user device 110; a Media Access Control (MAC) address associated with a user device 110; and/or another type of user device identifier. The location information associated with user device 110 may include seat and/or grid location information associated with the user, and/or may include location coordinates, such as GPS coordinates. Furthermore, registered users may be able to customize their registration status. For example, a user may report that the user will be away from the user's mapped location during a particular time period, or a user may select to opt out of participating during a particular time period.

Promotion DB 630 may store information relating to advertisements, promotions, and/or rewards associated with the sequence script and may map a particular advertisement, promotion, and/or reward to one or more registered user devices 110. Venue interface 640 may communicate with venue 105. For example, venue interface 640 may communicate with a computer device associated with venue 105, which is configured to monitor the venue event and which may provide information about the venue event to orchestration system 140. The information may include, for example, information identifying particular trigger events associated with the venue event.

User device interface 650 may communicate with registered user devices 110. For example, user device interface 650 may provide an action script to a user device 110 and may instruct user device 110 to execute the action script at a particular time. Designer system interface 660 may communicate with designer system 130. For example, designer system interface 660 may receive a sequence script from designer system 130.

Although FIG. 6 shows exemplary functional components of orchestration system 140, in other implementations, orchestration system 140 may include fewer functional components, different functional components, differently arranged functional components, or additional functional components than those depicted in FIG. 6. Additionally or alternatively, one or more functional components of orchestration system 140 may perform functions described as being performed by one or more other functional components of orchestration system 140.

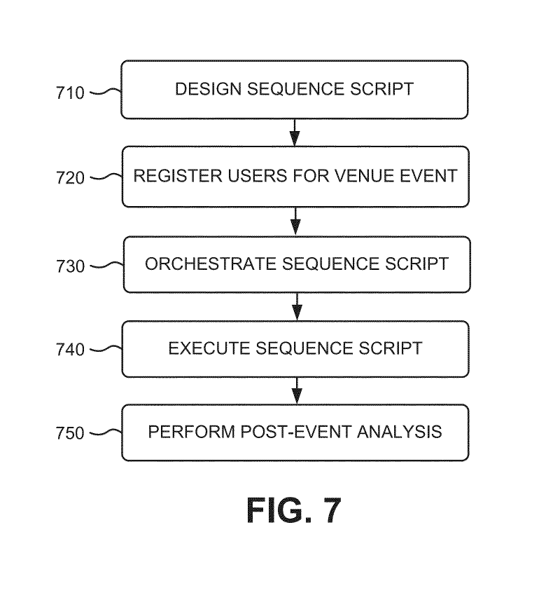

FIG. 7 is a flowchart for generating and executing a sequence script according to an implementation described herein. In one implementation, the process of FIG. 7 may be performed by one or more of designer system 130, orchestration system 140, promotion system 150, and/or analysis system 160. In other implementations, some or all of the process of FIG. 7 may be performed by another device or a group of devices separate from or including designer system 130, orchestration system 140, promotion system 150, and/or analysis system 160.

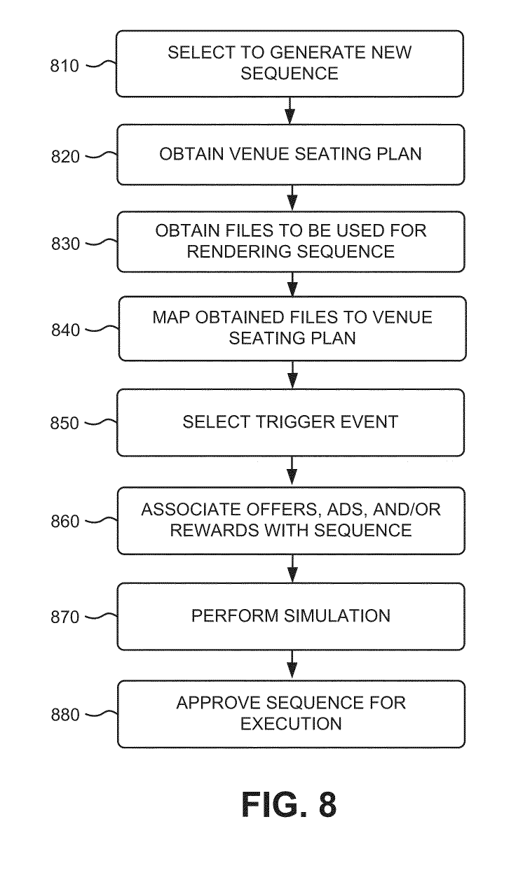

The process of FIG. 7 may include designing a sequence script (block 710). For example, a designer may use designer system 130 to create a new sequence script for a sequence to be executed during a venue event. A process for designing a new sequence script is described below in more detail with reference to FIG. 8.

Users may be registered for a venue event (block 720). A user may be able to register for the venue event using one of multiple registration methods. As an example, the user may register for the venue event by scanning a QR code associated with the venue event. The QR code may be provided on a ticket, poster, web site, and/or other type of content associated with the venue event. As another example, the user may be able to register for the venue event by scanning the user's ticket when arriving at the venue event. As yet another example, an invitation may be sent to the user (e.g., via email) in response to the user buying a ticket for the venue event and the user may register by responding to the invitation.

As yet another example, the user may register via a wireless transceiver associated with the venue event. For example, venue 105 may include WiFi access points, small cell base stations, and/or other types of wireless transceivers located in venue 105. When the user arrives at his or her seat, the wireless transceiver may detect the user's user device 110 and may send an invitation to user device 110 to register for the venue event. As yet another example, the user may register for the venue event via communicating with another user device 110 at the venue event. For example, if the other user device 110 has registered for the venue event, the other user device 110 may include venue participation application 300. Venue participation application 300 may, at particular intervals, look for nearby user devices 110 using a Bluetooth connection, an NFC connection, and/or another type of short distance wireless communication method. Venue participation application 300 may send an invitation to user device 110 to register with the venue event and, if the user accepts the invitation, may facilitate user device 110 to register for the venue event.

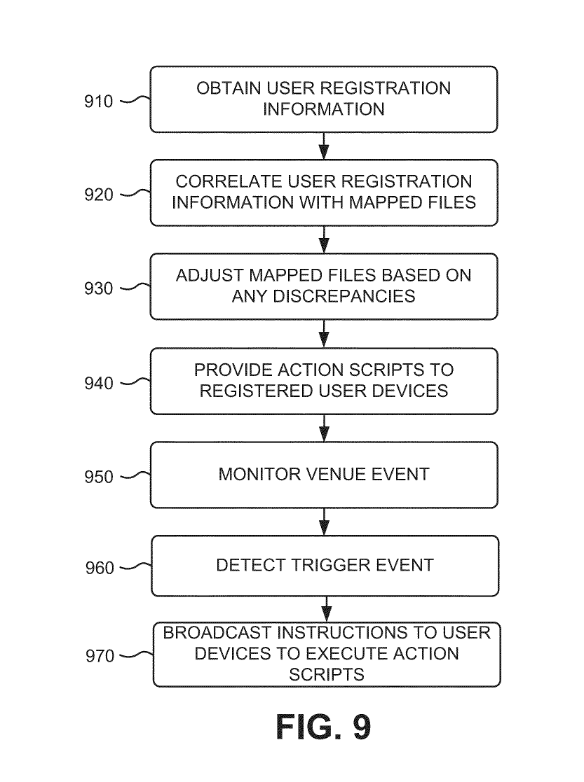

The sequence script may be orchestrated (block 730) and the sequence script may be executed (block 740). For example, orchestration system 140 may receive a sequence script from designer system 130, may obtain information identifying registered user devices 110, and may provide action scripts associated with the sequence script to the registered user devices 110. A process for orchestrating and executing the sequence script is described below in more detail with reference to FIG. 9.

Post-event analysis may be performed (block 750). For example, analysis system 160 may collect information relating to the executed sequence script from the registered user devices and may perform analysis on the collected information. Analysis system 160 may determine a participation rate associated with a sequence script, may determine a satisfaction rate associated with the sequence script, may determine a number of advertisements presented in connection with the sequence script, may determine a number of redeemed rewards associated with the sequence script, and/or may perform other types of analysis on collected information.

FIG. 8 is a flowchart for designing a sequence script according to an implementation described herein. In one implementation, the process of FIG. 8 may be performed by designer system 130. In other implementations, some or all of the process of FIG. 8 may be performed by another device or a group of devices separate from and/or including designer system 130.

The process of FIG. 8 may include selecting to generate a new sequence (block 810). For example, a designer may use developer module 510 to activate a user interface to create a new sequence script for a sequence to be executed during a venue event. A venue seating plan may be obtained (block 820). As an example, designer system 130 may obtain a seating plan, and/or another type of map of venue 105, from venue 105 and may store the obtained seating plan in venue DB 530. As another example, designer system 130 may obtain a floor plan for venue 105 and may partition the floor plan into a grid.

Files to be used for rendering the sequence may be obtained (block 830). As an example, the designer may enter a textual message, may upload an image file, a video file, an animation, and/or another type of file. As another example, the designer may create a pattern using a graphical interface. The obtained files may be mapped to the venue seating plan (block 840). For example, developer module 510 may divide a particular image from the uploaded or generated patterns into a set of sequence pixels. A sequence pixel may correspond to a single pixel from the particular image or to a group of pixels from the particular image. Each sequence pixel may be mapped to a particular element of the seating plan and/or map associated with the venue. Each element may correspond to a single seat and/or map grid element of the seating plan and/or map, or may correspond to a set of seats and/or map grid elements.

A trigger event may be selected (block 850). For example, the designer may select as the trigger event a manual instruction from an administrator associated with the venue event to execute the sequence script. As another example, a trigger event may correspond to a particular time period during the venue event (e.g., the beginning of half time during a sports game, the seventh inning stretch, etc.). As yet another example, a trigger event may correspond to a particular event occurring during the venue event (e.g., a team scoring, etc.). As yet another example, a trigger event may correspond to users selecting to execute the sequence script. For example, users may access a menu provided by venue participation application 330 via user interface 360. The venue may list available sequence scripts to be executed (e.g., an audience wave, displaying the team logo, spelling out an encouraging message, etc.) and users may vote to select to execute a particular sequence. If a threshold number of votes (e.g., an absolute number of votes, a percentage of registered users voting, etc.) is received, a trigger event to execute the action script may be detected.

Advertisements, promotions, and/or rewards may be associated with the sequence (block 860). As an example, the designer may select one or more categories, keywords, time periods, and/or other properties for the generated sequence, and promotion system 150 may select one or more advertisements and/or promotions to be associated with the sequence. Furthermore, the designer and/or promotion system 150 may select one or more rewards for the sequence. A reward may be provided to a user in return for either registering or for participating in executing the sequence. For example, a reward may include a coupon for purchasing products or services at the venue during the venue event.

A simulation may be performed (block 870) and the sequence may be approved for execution (block 880). For example, the designer may activate simulator 560, which may simulate the generated sequence script using a particular set of simulated registered devices. For example, the designer may define a distribution of registered devices in venue 105 during the simulated venue event and a simulation may be performed using the defined distribution of registered devices. The simulation may generate an image and/or animation of venue 105 as it would appear while the sequence script is being executed. If the designer is satisfied with the simulation, the designer may approve the generated sequence script for execution. If the designer is not satisfied with the simulation, the designer may modify the sequence script and run another simulation.

FIG. 9 is a flowchart orchestrating a sequence script according to an implementation described herein. In one implementation, the process of FIG. 9 may be performed by orchestration system 140. In other implementations, some or all of the process of FIG. 9 may be performed by another device or a group of devices separate from or including orchestration system 140.

The process of FIG. 9 may include obtaining user registration information (block 910). For example, a user may register user device 110 as described above with reference to block 720 of FIG. 7. Registration information associated with registered user devices 110 may be stored in registration DB 625 in association with the venue event. In response to registering for the venue event, orchestration system 140 may provide venue participation application 300 to registered user devices 110.

User registration information may be correlated with the mapped files (block 920). For example, sequence execution module 610 may map, using the location information obtained during the registration process, the registered user devices 110 onto the seating chart and/or other type of location grid map associated with venue 105. Sequence execution module 610 may then map the images from the sequence onto the registered user devices 110 based on the mapping generated by designer system 130. Thus, each pixel, or set of pixels, associated with an image in the sequence, may be mapped to a particular user device 110, or set of user devices 110.

Mapping of images from the sequence onto registered user devices 110 may include validating location of user devices 110. For example, a particular user may not be in the user's seat or at a previously determined location. Thus, the location of each participating user device 110 may be validated in real-time or near real-time. Validation of the location of registered user devices 110 may be performed using a micro-location method, a beaconing method, a user validation method, and/or using another method. A micro-location method may use multilateration methods using wireless receivers located at venue 105, such as WiFi access points, Bluetooth transceivers, and/or other types of wireless transceiver located at venue 105. A beaconing method may use user device 110 to user device 110 communication, such as by using the location of a first device 110 and a wireless link between the first device 110 and a second user device 110 (e.g, a Bluetooth, NFC, and/or infrared link between first and second user devices 110). A user validation method may include the user either validating the location via user input or by scanning a code (e.g., QR code, barcode, etc.) associated with an identified location, such as a code located on the user's seat.

The mapped files may be adjusted based on any discrepancies (block 930). For example, a sequence may include an image mapped to a section of venue 105 that does not include any registered users. Thus, when rendering the image during the venue event, the rendered image may include a hole. As an example, orchestration system 140 may move a particular image to a location in the seating chart, and/or other type of location grid, where there is a sufficient number of registered user devices 110. Thus, the image may be moved further down a seating section, for example. In other implementations, orchestration system 140 may be configured to perform additional adjustments. For example, orchestration system 140 may stretch or compress a portion of an image to take into account an area with missing registered user devices 110.

Action scripts may be provided to registered user devices (block 940). For example, sequence execution module 610 may, via user device interface 650, provide an action script, associated with a particular seat and/or location in the sequence script, to registered user device 110. Different user devices 110 may receive different action scripts, depending on where in an image to be formed the different user devices 110 are located. Venue participation application 300 may receive an action script and store the action script in sequence DB 320.

The venue event may be monitored (block 950) and a trigger event may be detected (block 960). As an example, sequence execution module 610 may receive, via venue interface 640, an indication that a particular event has occurred that corresponds to a trigger event associated with the sequence script. As another example, sequence execution module 610 may receive, via user device interface 650, a request from one or more registered user devices 110 to execute a particular sequence script and may determine that the number of requests exceeds a threshold and thus corresponds to a trigger event. In response to the detected trigger event, instructions may be broadcast to the user devices to execute the action scripts (block 970). For example, sequence execution module 610 may instruct the registered user devices 110 to execute action scripts provided to the registered user devices 110.

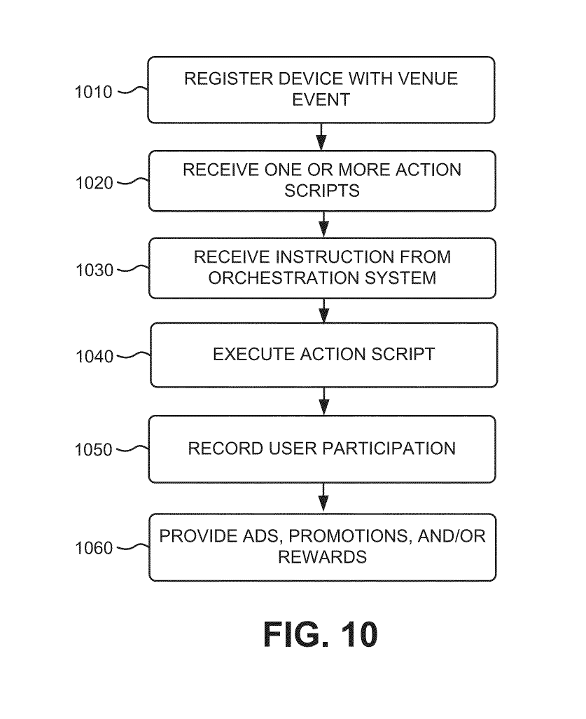

FIG. 10 is a flowchart for executing a sequence script according to an implementation described herein. In one implementation, the process of FIG. 10 may be performed by user device 110. In other implementations, some or all of the process of FIG. 10 may be performed by another device or a group of devices separate from or including user device 110.

The process of FIG. 10 may include registering the user device with a venue event (block 1010). For example, the user may perform a registration process as described above with reference to block 720 of FIG. 7. One or more action scripts may be received (block 1020). For example, orchestration system 140 may provide venue participation application 300 to user device 110 and user device 110 may install venue participation application 300 on user device 110. Furthermore, venue participation application 300 may receive information relating to one or more sequences and may store the received information in sequence DB 320. The received sequence information may include one or more action scripts for each sequence. Moreover, venue participation application 300 may receive information relating to advertisements, promotions, and/or rewards associated with a sequence and may store the received information in promotion DB 350.

Instruction from an orchestration system may be received (block 1030) and an action script may be executed (block 1040). For example, at some time during the venue event, orchestration system 140 may detect a trigger event and may instruct user device 110 to execute an action script associated with the sequence. The action script may include, for example, providing instructions to the user (e.g., “hold up your phone and point it at the field now”) and may cause user device 110 to display an image and/or animation, to play an audio file, to cause a camera flash device to activate, and/or to perform one or more other actions.

User participation may be recorded (block 1050). For example, data collection module 370 may determine whether a user has participated in the execution of the sequence. User participation may be determined based on the user confirming receipt of instructions, based on a sensor included in user device 110 (e.g., an accelerometer detects that the user has lifted user device 110 according to instructions, etc.), based on detecting that an output device of user device 110 has been activated, and/or using another method.

Advertisements, promotions, and/or rewards may be provided (block 1060). For example, promotion module 340 may monitor user participation and may provide a user with a reward in return for participating in a sequence. For example, the user may receive a coupon for buying concessions at the venue event. As another example, an advertisement may be displayed on the user's device after executing the action script for the sequence. As yet another example, an advertisement may be formed during the sequence by the participating user devices. Thus, the action script may include one or more actions that cause user device 110, together with other participating user devices 110, to form an image or set of images that includes an advertisement.

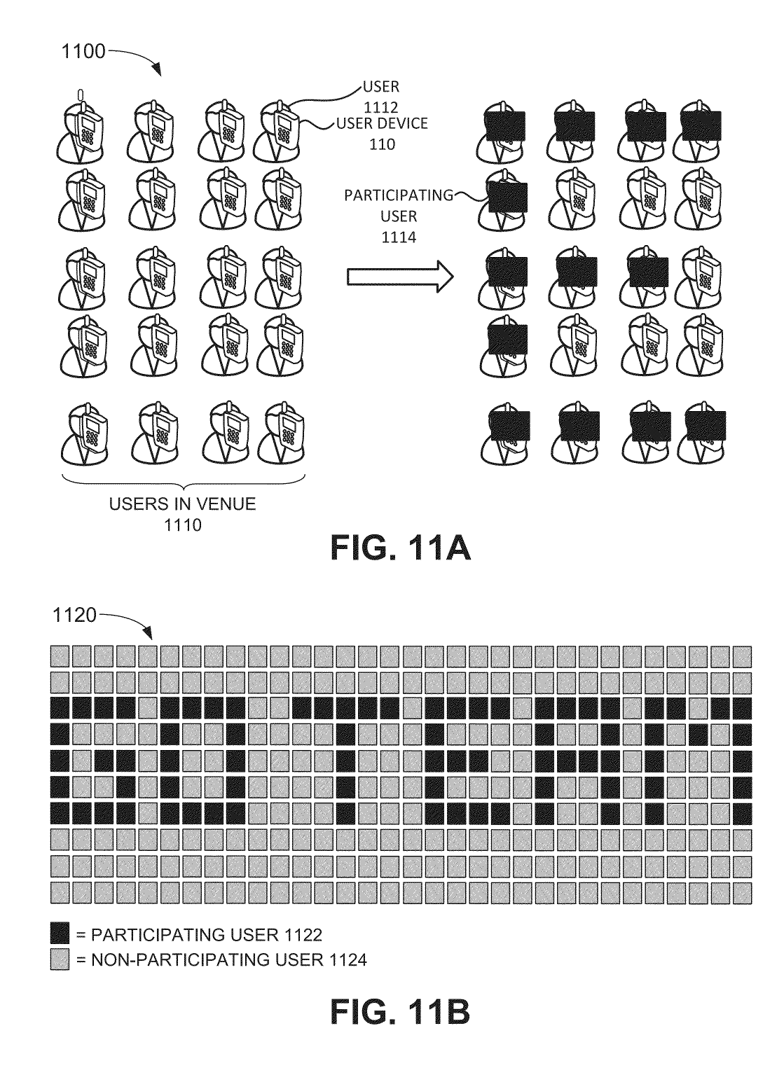

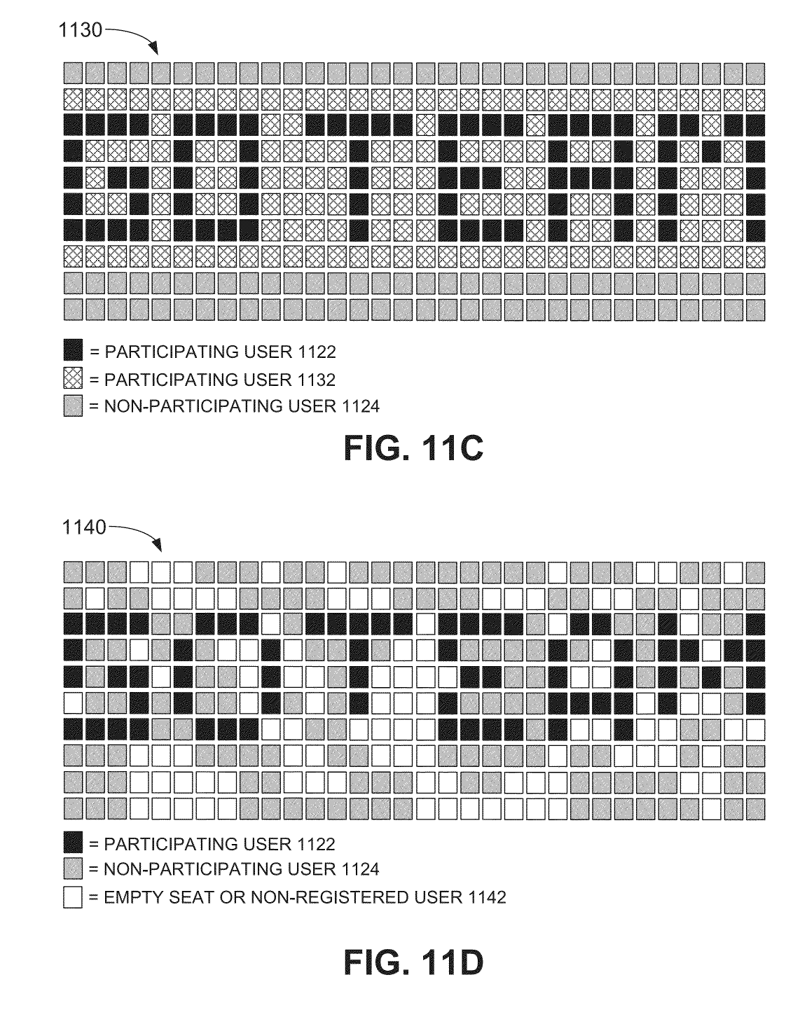

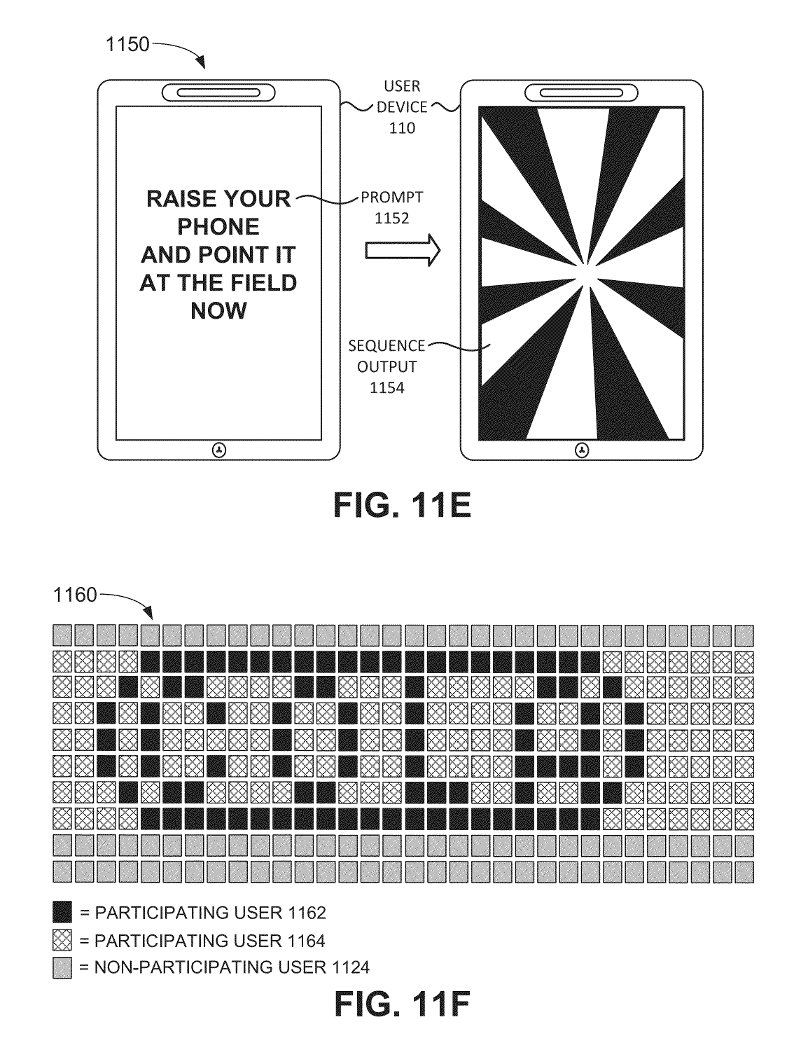

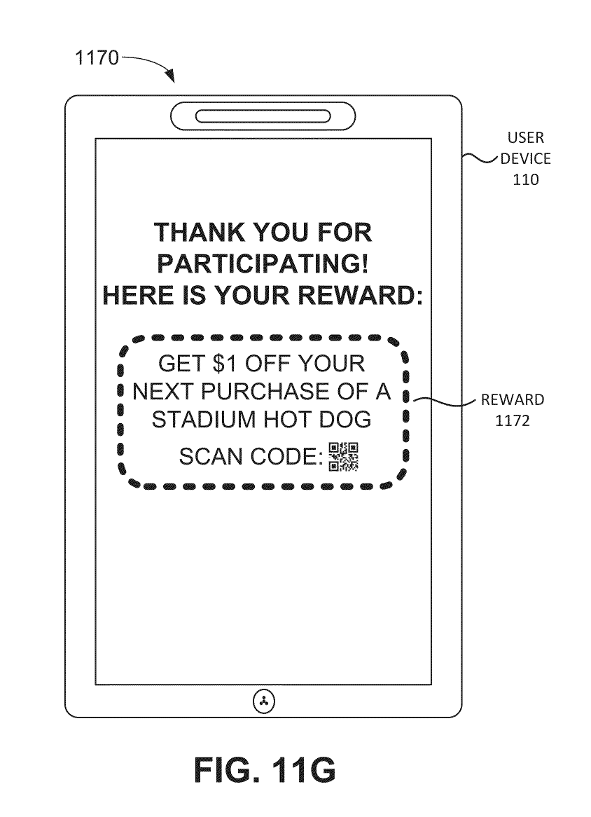

FIGS. 11A-11G are diagrams illustrating a first exemplary scenario according to an implementation described herein. FIG. 11A illustrates a section 1100 of users 1110 seated in a venue (e.g., users sitting in a stadium). Each particular user 1112 may have a user device 110. Assume all users are registered with orchestration system 140. When a sequence script is executed, participating users 1114 may hold up their user devices 110, which may light up their screens to together spell out the letter “E.”

FIG. 11B shows a section 1120 of the venue that includes a rendered image, which in this case is a message spelling out “GO TEAM.” Participating users 1122 may hold up user devices 110 with activated screens, while user devices 110 of non-participating users 1124 may not become activated. FIG. 11C shows a section 1130 with an alternative implementation. In FIG. 11C, to encourage participation of more users, the message may include a lighted background of a different color than the spelled out “GO TEAM” message. Thus, participating users 1122 may hold up user devices 110 with activated screens of a first color to spell out the letters of the message, and participating users 1132 may hold up user devices 110 with activated screens of a second color to provide a background for the message.

FIG. 11D shows an implementation of a section 1140 of a venue that is either sparsely populated or includes a significant number of non-registered users, with empty seats or non-registered users 1142. Orchestration system 140 may adjust the image to be rendered by stretching or compressing parts of the image, or by adjusting the shapes of the letters to take into account the empty or non-registered seats. Adjustments such as the one shown in FIG. 11D may be approved during a simulation of the sequence script. For example, a designer may cycle through possible distributions of empty seats or non-registered users and may either approve adjustments (if a message is still readable or if an image is still recognizable), or may disapprove an adjustment if an image or message becomes too distorted. In situations where a section includes too many empty seats or non-registered users, a sequence may not be executed.

FIG. 11E illustrates an action script execution 1150 of a participating user device 110. The action script may include generating a user interface that includes a prompt 1152 to the user, instructing the user to perform a particular action, such as holding up user device 110 and pointing user device 110 at the field of a stadium. Prompt 1152 may be accompanied, for example, with an audible countdown. After a particular length of time (e.g., 5-10 seconds), the action script may cause user device 110 to display an output sequence 1154 (e.g., flashing lights).

FIG. 11F illustrates a section 1160 in which an advertisement is formed as part of a sequence script. For example, after displaying the message “GO TEAM,” as shown in FIG. 11C, an advertisement may be displayed, which in the example of FIG. 11F includes a logo with the word “COLA.” Thus, participating users 1162 may hold up user devices 110 with activated screens of a first color to generate the logo, and participating users 1164 may hold up user devices 110 with activated screens of a second color to provide a background for the logo. FIG. 11G illustrates a reward 1170 being provided to a user for participating in the execution of a sequence. Venue participation application 300 may display a reward 1172, which in this case corresponds to a coupon for a hot dog that can be redeemed with a scan code when the user buys a hot dog.

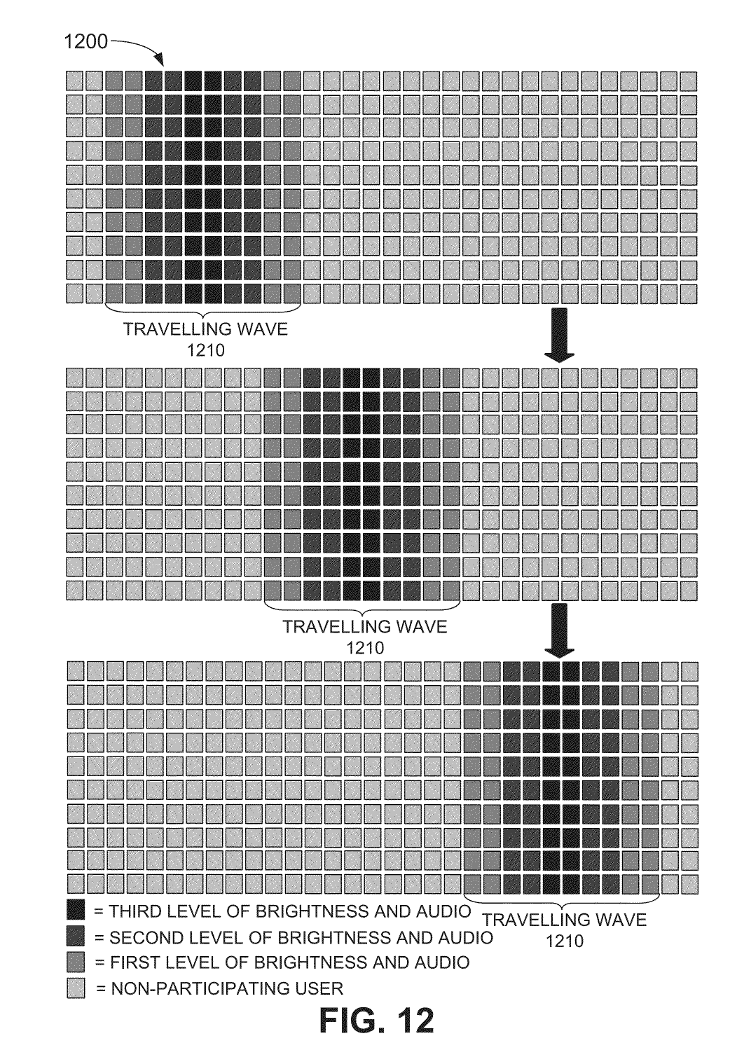

FIG. 12 is a diagram illustrating a second exemplary scenario 1200 according to an implementation described herein. As shown in FIG. 12 scenario 1200 may include an audience travelling wave 1210 implemented using registered user devices 110. As users hold up user devices 110, travelling wave 1210 may travel across a section of venue 105 (e.g., across a section of stadium seats). Each user device 110 participating in travelling wave 1210 may be outputting a different level of brightness and audio. For example, user devices 110 at the edges of travelling wave 1210 may light up their touchscreens at a first level of brightness and may output a sound at a first level of loudness. User devices towards the middle of travelling wave 1210 may light up their touchscreens at a second level of brightness and may output a sound at a second level of loudness. User devices in the middle of travelling wave 1210 may light up their touchscreens at a third level of brightness and may output a sound at a third level of loudness. The three levels of brightness and loudness may generate an impression of a cresting wave across the venue.

Another exemplary scenario may include a static and/or dynamic image, such as a U.S. flag, being displayed by a group of user devices 110 as the users move from one part of venue 105 to another part. As the users move (e.g., walk, drive, etc.), the image may change dynamically to simulate a flag flapping in the wind.

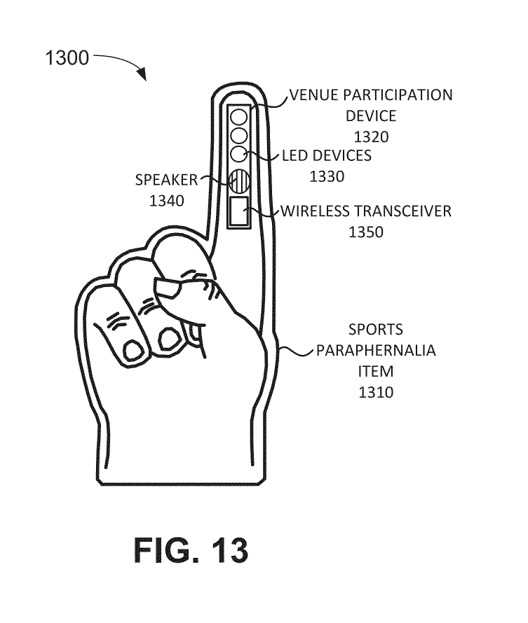

FIG. 13 is a diagram of an exemplary user device 1300 according to an implementations described herein. As shown in FIG. 13, user device 1300 may include a sports paraphernalia item 1310 that includes a venue participation device 1320. Venue participation device 1320 may include LED devices 1330 (and/or another type of display device), a speaker 1340, and a wireless transceiver 1350. Venue participation device 1320 may include venue participation application 300 installed, for example, on an ASIC chip. User device 1300 may be sold or handed out at the venue during a venue event and may be automatically registered for the venue event. For example, when a user obtains user device 1300, the user may provide seat information, and/or other location information, and the information may be associated with user device 1300 by sending the information to orchestration system 140. During execution of a sequence script, the user may hold up sports paraphernalia item 1310 and LED devices 1330 may light up in a particular pattern. A group of users holding up sports paraphernalia items 1310 may spell out a message or form an image when LED devices 1330 light up. Additionally, speakers 1340 may play an audio sound (e.g., a sports team jingle) while LED devices 1330 are lit up.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 7-10, the order of the blocks may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method, performed by one or more computer devices, the method comprising:
generating, by at least one of the one or more computer devices, a sequence script for a venue event, wherein the sequence script is configured to synchronize a plurality of user devices during the venue event to form one or more images;
obtaining, by at least one of the one or more computer devices, user registration information associated with the venue event, wherein the user registration information identifies user devices registered to participate in the generation of the one or more images;
detecting, by at least one of the one or more computer devices, a trigger event associated with the sequence script; and
orchestrating, by at least one of the one or more computer devices, the plurality of user devices to form the one or more images, in response to detecting the trigger event.

2. The method of claim 1, wherein a particular one of the plurality of user devices corresponds to a particular pixel of the one or more images.

3. The method of claim 1, wherein generating the sequence script for the venue event includes:
obtaining a seating plan for the venue event;
obtaining one or more image files for the one or more images; and
mapping the obtained one or more image files to the obtained seating plan.

4. The method of claim 3, further comprising:
correlating the obtained user registration information with the obtained seating plan;
detecting an area in the obtained seating plan that does not include registered users; and
adjusting the mapping based on the detected area.

5. The method of claim 1, wherein obtaining the user registration information associated with the venue event includes detecting that a user has registered to participate in the generation of the one or more images based on at least one of:
the user scanning a quick response code associated with the venue event, the user scanning a ticket associated with the venue event,
the user responding to an invite to register in response to purchasing a ticket for the venue event,
the user registering via a wireless transceiver associated with the venue event, or
the user registering via communicating with a user device associated with another user at the venue event.

6. The method of claim 1, wherein the trigger event includes at least one of:
an instruction received from an administrator associated with the venue event;
detecting a team scoring during the venue event; or
detecting a break during the venue event.

7. The method of claim 1, wherein orchestrating the plurality of user devices to form the one or more images includes at least one of:
sending an instruction to a user to perform a particular action with a user device;
instructing the user device to vibrate, play an audio file, or display an image; or
instructing the user device to activate a flash.

8. The method of claim 1, further comprising:
associating at least one of an advertisement, promotion, or reward with the sequence script.

9. The method of claim 8, further comprising:
determining that a user has participated in forming the one or more images; and
providing a reward to the user, in response to determining that the user has participated in forming the one or more images.

10. The method of claim 8, further comprising:
displaying an advertisement to the user in connection with orchestrating the plurality of user devices to form the one or more images.

11. The method of claim 8, wherein the one or more images include an advertisement.

12. The method of claim 1, further comprising:
collecting participation information in connection with orchestrating the plurality of user devices to form the one or more images; and
performing analysis on the collected participation information.

13. The method of claim 12, wherein performing the analysis on the collected participation information includes at least one of:
determining a participation rate associated with the sequence script;
determining a satisfaction rate associated with the sequence script;
determining a number of advertisements presented in connection with the sequence script; or
determining a number of redeemed rewards associated with the sequence script.

14. One or more computer devices comprising:
logic configured to:
generate a sequence script for a venue event, wherein the sequence script is configured to synchronize a plurality of user devices during the venue event to form one or more images;
obtain user registration information associated with the venue event, wherein the user registration information identifies user devices registered to participate in the generation of the one or more images;
detect a trigger event associated with the sequence script; and
orchestrate the plurality of user devices to form the one or more images, in response to detecting the trigger event.

15. The one or more computer devices of claim 14, wherein, when generating the sequence script for the venue event, the logic is further configured to:
obtain a seating plan for the venue event;
obtain one or more image files for the one or more images; and
map the obtained one or more image files to the obtained seating plan.

16. The one or more computer devices of claim 14, wherein the logic is further configured to:
provide a reward to the user, in response to determining that the user has participated in forming the one or more images; or
display an advertisement to the user in connection with orchestrating the plurality of user devices to form the one or more images.

17. The one or more computer devices of claim 14, wherein the logic is further configured to:
collect participation information in connection with orchestrating the plurality of user devices to form the one or more images; and
perform analysis on the collected participation information.

18. A user device comprising:
logic configured to:
register with a venue event;
receive, from an orchestration device, a sequence action script associated with the venue event;
detect a trigger event associated with a sequence action script; and
execute an action sequence associated with the sequence action script, in response to detecting the trigger event, wherein the action sequence includes causing the user device to participate in the generation of the one or more images together with a plurality of other user devices.

19. The user device of claim 18, wherein, when the logic is configured to execute the action sequence associated with the sequence action script, the logic is further configured to control a peripheral device to generate audio or visual output.

20. The user device of claim 18, wherein the user device is configured to operate within a particular distance of a venue associated with the venue event.
